(19) United States
(12) Patent Application Publication
(10) Pub. No.: US 2019/0153208 A1
(43) Pub. Date: May 23, 2019

(54) INSULATING RESIN COMPOSITION AND INSULATED ELECTRIC WIRE

(71) Applicant: SUMITOMO ELECTRIC INDUSTRIES, LTD., Osaka-shi, Osaka (JP)

(72) Inventors: Shigeyuki TANAKA, Osaka-shi, Osaka (JP); Taro FUJITA, Osaka-shi, Osaka (JP); Shinya NISHIKAWA, Osaka-shi, Osaka (JP); Atsuko SHINOMIYA, Kanuma-shi, Tochigi (JP); Hiroyuki OKAWA, Kanuma-shi, Tochigi (JP)

(73) Assignee: SUMITOMO ELECTRIC INDUSTRIES, LTD., Osaka-shi, Osaka (JP)

(21) Appl. No.: 16/318,493

(22) PCT Filed: Jul. 12, 2017
(86) PCT No.: PCT/JP2017/025411

§ 371 Date: Jan. 17, 2019

(30) Foreign Application Priority Data
Jul. 22, 2016 (JP) 2016-144716

(51) Int. Cl. C08L 23/30; C08L 23/20; C08L 23/08; H01B 3/44

(52) U.S. Cl. CPC C08L 23/30; C08L 23/20; C08L 23/0869; H01B 3/441; H01B 3/447; H01B 7/292; C08L 2205/03; C08L 2201/02; C08L 2312/00; C08L 2203/202; C08L 2205/025

(57) ABSTRACT

Provided is an insulating resin composition that contains a resin component containing a first copolymer which is a copolymer of ethylene and an unsaturated hydrocarbon having 4 or more carbon atoms, a second copolymer which is a copolymer of ethylene and an unsaturated hydrocarbon having 4 or more carbon atoms, which is subjected to acid modification, and which has a density of less than 0.88 g/cm³, and a third copolymer which is a copolymer of ethylene and an acrylic acid ester or the like, in which a ratio of contents of the first to third copolymers is within a specific range, and 30 to 100 parts by mass of a flame retardant and 1 to 5 parts by mass of a crosslinking assistant relative to 100 parts by mass of the resin component.

### TECHNICAL FIELD

The present invention relates to an insulating resin composition and an insulated electric wire produced by using the insulating resin composition.

The present application claims priority from Japanese Patent Application No. 2016-144716 filed on Jul. 22, 2016, and the entire contents of the Japanese patent application are incorporated herein by reference.

### BACKGROUND ART

Insulated electric wires and electric cables (hereinafter, electric cables may also be referred to as “insulated electric wires”) used for, for example, wiring in vehicles are required to have good flexibility for ease of cable routing and space saving. As an insulated electric wire having good flexibility, for example, PTL 1 discloses an insulated electric wire including an insulating coating formed of a halogen-free resin composition that contains a base resin containing a polypropylene resin, a propylene-α-olefin copolymer, and a low-density polyethylene resin, a metal hydrate, a phenolic antioxidant, etc. and a wire harness including the insulated electric wire. The insulated electric wire and the wire harness are also described as those having good mechanical properties such as abrasion resistance, flame retardancy, and long-term heat resistance (heat-aging resistance) in addition to flexibility.

For applications to, for example, hybrid vehicles and electric vehicles, which have been developed in recent years, an increase in diameters of conductors is required so that a large current can be supplied. Accordingly, in order to realize an increase in diameters of conductors, further improvements in flexibility have been desired. Furthermore, in order to manage generation of a large quantity of heat due to supply of a current, improvements in heat resistance have also been desired. PTL 2 discloses an insulating resin composition which enables production of an insulated electric wire that combines flexibility and heat resistance good enough to fulfil the recent requirements described above and which can provide creep durability for achieving a sufficient water-cut-off performance (terminal water cut-off structure).

The insulating resin composition contains a resin containing a first copolymer which is a copolymer of ethylene and an unsaturated hydrocarbon having 4 or more carbon atoms and which has a density of less than 0.88 g/cm³, and a second copolymer which is a copolymer of ethylene and an acrylic acid ester or a methacrylic acid ester

at a ratio of the first copolymer to the second copolymer (mass ratio) of 100:0 to 40:60; and

30 to 100 parts by mass of a flame retardant and 1 to 5 parts by mass of a crosslinking assistant relative to 100 parts by mass of the resin. PTL 2 further discloses an insulated electric wire (which also covers an electric cable) that includes an insulating layer formed of a crosslinked material of this insulating resin composition and that has good flexibility, heat resistance, and water-cut-off performance (terminal water cut-off structure).

### CITATION LIST

### Patent Literature

PTL 1: Japanese Unexamined Patent Application Publication No. 2009-127040

PTL 2: International Publication No. WO 2015/159788

### SUMMARY OF INVENTION

A first embodiment of the present invention is

an insulating resin composition containing

a resin component containing
a first copolymer which is a copolymer of ethylene and an unsaturated hydrocarbon having 4 or more carbon atoms and which has a density of less than 0.88 g/cm³,
a second copolymer which is a copolymer of ethylene and an unsaturated hydrocarbon having 4 or more carbon atoms, which is subjected to acid modification, and which has a density of less than 0.88 g/cm³, and
a third copolymer which is a copolymer of ethylene and an acrylic acid ester or a methacrylic acid ester,
in which a content of the second copolymer is 10% by mass or more of a total content of the first copolymer, the second copolymer, and the third copolymer, and
a ratio (mass ratio) of a total content of the first copolymer and the second copolymer to a content of the third copolymer is 100:0 to 40:60; and

30 to 100 parts by mass of a flame retardant and 1 to 5 parts by mass of a crosslinking assistant relative to 100 parts by mass of the resin component.

A second embodiment of the present invention is

an insulated electric wire including a conductor and an insulating layer covering the conductor either directly or with another layer therebetween, in which the insulating layer is formed of a crosslinked material of the insulating resin composition of the first embodiment.

### BRIEF DESCRIPTION OF DRAWING

FIG. 1 is a perspective view illustrating a structure of an example (shielded electric wire) of an insulated electric wire.

### DESCRIPTION OF EMBODIMENTS

### Problem to be Solved by the Present Disclosure

In the existing insulated electric wire described above, an insulating layer and an electric-wire coating material formed by the insulating resin composition have insufficient tensile strength in some cases. Furthermore, in the case where an adhesive is used for water cut-off at a terminal of the insulated electric wire, there may be a problem in that, for example, the adhesion between the adhesive and the insulating layer or the electric-wire coating material is weak, and a strip force of the electric wire-coating material (a force necessary for pulling out a coating material from an electric wire) does not stabilize (the strip force is not within an appropriate range).

An object of the present invention is to provide an insulating resin composition serving as a material of an insulating layer of an insulated electric wire or a coating material of an electric wire (electric wire coating), the insulating resin composition being capable of forming an insulating layer or electric wire coating that has high tensile strength while maintaining good properties, such as flexibility, of the existing insulated electric wire, has good adhesion to an adhesive when the adhesive is used for water cut-off at a terminal, and has a stable strip force. Another object of the present invention is to provide an insulated electric wire that includes an insulating layer or electric wire coating formed of a crosslinked material of the insulating resin composition, maintains good properties, such as flexibility, of the existing insulated electric wire, has good tensile strength of the insulating layer or electric wire coating and good adhesion to an adhesive, and has a stable strip force.

The inventors of the present invention conducted intensive studies in order to achieve the objects described above. As a result, it was found that an insulating resin composition capable of providing an insulated electric wire having flexibility substantially as good as the existing insulated electric wire, and capable of forming an insulating layer or electric wire coating having high tensile strength, having good adhesion to an adhesive when the adhesive is used for water cut-off at a terminal, and having a stable strip force could be obtained by incorporating, in the insulating resin composition disclosed in PTL 2, a copolymer (very low-density polyethylene) of ethylene and an unsaturated hydrocarbon having 4 or more carbon atoms, the copolymer having a density of less than 0.88 g/cm³ and being subjected to acid modification. This finding led to the realization of the present invention.

### Advantageous Effects of the Present Disclosure

According to the first embodiment of the present invention, there is provided an insulating resin composition serving as a material of an insulating layer of an insulated electric wire or electric wire coating, the insulating resin composition being capable of providing an insulated electric wire having flexibility substantially as good as existing insulated electric wires, and capable of forming an insulating layer or electric wire coating having high tensile strength, having good adhesion to an adhesive when the adhesive is used for water cut-off at a terminal, and having a stable strip force.

According to the second embodiment of the present invention, there is provided an insulated electric wire that has good properties, such as flexibility, of existing insulated electric wires, and that includes an insulating layer or electric wire coating having good tensile strength and good adhesion to an adhesive, and having a stable strip force.

The insulating resin composition according to embodiments of the present invention is not limited thereto. The insulating resin composition can be suitably used for producing an insulated electric wire used for, for example, wiring in vehicles.

### DESCRIPTION OF EMBODIMENTS OF THE PRESENT INVENTION

Next, embodiments for carrying out the present invention will be described. The embodiments do not limit the scope of the present invention, and various modifications can be made without departing from the gist of the present invention. The scope of the present invention is defined by the appended claims and is intended to cover all the modifications within the meaning and scope equivalent to those of the claims.

A first embodiment of the present invention is

an insulating resin composition containing

a resin component containing
a first copolymer which is a copolymer of ethylene and an unsaturated hydrocarbon having 4 or more carbon atoms and which has a density of less than 0.88 g/cm³,
a second copolymer which is a copolymer of ethylene and an unsaturated hydrocarbon having 4 or more carbon atoms, which is subjected to acid modification, and which has a density of less than 0.88 g/cm³, and
a third copolymer which is a copolymer of ethylene and an acrylic acid ester or a methacrylic acid ester,
in which a content of the second copolymer is 10% by mass or more of a total content of the first copolymer, the second copolymer, and the third copolymer, and
a ratio (mass ratio) of a total content of the first copolymer and the second copolymer to a content of the third copolymer is 100:0 to 40:60; and

30 to 100 parts by mass of a flame retardant and 1 to 5 parts by mass of a crosslinking assistant relative to 100 parts by mass of the resin component.

When an insulating layer of an insulated electric wire is formed by using the insulating resin composition of the first embodiment and the resin is crosslinked, an insulated electric wire having good flexibility that enables easy cable routing can be produced. Furthermore, the insulating layer formed of a crosslinked material of the insulating resin composition has high tensile strength, good adhesion to an adhesive when the adhesive is used for water cut-off at a terminal of the insulated electric wire, and a stable strip force.

An example of the method for crosslinking the resin is a method of irradiating the resin with an ionizing radiation. Examples of the ionizing radiation include high-energy electromagnetic waves such as X rays and y rays, and particle beams. An electron beam is preferred from the viewpoint that, for example, irradiation can be performed with a relatively inexpensive apparatus and easily controlled, and high energy is easily obtained.

The first copolymer contained in the insulating resin composition is a polyolefin resin which is a copolymer of ethylene and an unsaturated hydrocarbon having 4 or more carbon atoms and which has a density of less than 0.88 g/cm³. When a polyolefin resin having a density of 0.88 g/cm³ or more is used as the first copolymer, it is difficult to achieve flexibility that fulfills the recent requirements. When a copolymer of ethylene and an unsaturated hydrocarbon having 3 or less carbon atoms is used, it is difficult to achieve good heat-resistant life, and good creep durability and water-cut-off performance. Furthermore, the modulus of elasticity at a high temperature (for example, 150° C.) decreases because it is difficult to cause crosslinking of the resin to efficiently proceed.

Examples of the polyolefin resin include ethylene-butene copolymers (EB) and ethylene-octene copolymers (EO). Among these, EB are preferably used because good balance among flexibility, heat-resistant life, and creep durability is achieved.

Commercially available products can be used as the first copolymer. Examples of EB include commercially available products such as ENGAGE 7467 (manufactured by The Dow Chemical Company, density 0.862), TAFMER DF610 (manufactured by Mitsui Chemicals, Inc., density 0.862), and TAFMER DF710 (manufactured by Mitsui Chemicals, Inc., density 0.870). Examples of EO include commercially available products such as ENGAGE 8842 (manufactured by The Dow Chemical Company, density 0.857).

The second copolymer contained in the insulating resin composition is a polyolefin resin which is a copolymer of ethylene and an unsaturated hydrocarbon having 4 or more carbon atoms, which is subjected to acid modification, and which has a density of less than 0.88 g/cm³. Herein, the term “acid modification” refers to graft modification of a copolymer of ethylene and an unsaturated hydrocarbon having 4 or more carbon atoms with an unsaturated carboxylic acid or a derivative thereof.

As a result of graft modification, the copolymer has an acidic group such as a carboxyl group.

Examples of the unsaturated carboxylic acid or the derivative thereof (graft monomer) used for the graft modification of the copolymer include unsaturated carboxylic acids such as maleic acid, fumaric acid, tetrahydrophthalic acid, itaconic acid, citraconic acid, crotonic acid, isocrotonic acid, nadic acid, acrylic acid, and methacrylic acid or derivatives thereof such as acid anhydrides, imides, amide, and esters of any of the above unsaturated carboxylic acids. Among these, acid anhydrides of the unsaturated carboxylic acids are preferred, and in particular, maleic anhydride is preferred.

The graft modification can be performed by using a known method. Examples of the method include a melt-modification method in which a copolymer is melted, a graft monomer is added thereto, and the resulting mixture is subjected to graft copolymerization, and a solution modification method in which a copolymer is dissolved in a solvent, a graft monomer is added thereto, and the resulting solution is subjected to graft copolymerization. The reaction of the graft modification is preferably performed in the presence of a radical initiator. The reaction temperature in this case is usually in the range of 60° C. to 350° C. Examples of the radical initiator include organic peroxides such as dicumyl peroxide, di-tert-butyl peroxide, 2,5-dimethyl-2,5-di(tert-butylperoxy)hexane-3, 2,5-dimethyl-2,5-di(tert-butylperoxy)hexane, and 1,4-bis(tert-butylperoxyisopropyl)benzene.

In order to achieve good compatibility with other resins, the amount of the graft monomer is preferably in the range of 0.01% to 10% by mass, and in particular, in the range of 1% to 5% by mass relative to the copolymer to be modified in the acid modification.

The density of the second copolymer is less than 0.88 g/cm³. At a density 0.88 g/cm³ or more, it is difficult to achieve flexibility that fulfills the recent requirements. Furthermore, the modulus of elasticity at a high temperature (for example, 150° C.) decreases because it is difficult to cause crosslinking of the resin to efficiently proceed. The unsaturated hydrocarbon constituting the second copolymer is also an unsaturated hydrocarbon having 4 or more carbon atoms. When the number of carbons of the unsaturated hydrocarbon is 3 or less, it is difficult to achieve good heat-resistant life, and good creep durability and water-cut-off performance.

Examples of the polyolefin resin serving as the second copolymer include acid-modified products of EB and acid-modified products of EQ. Among these, acid-modified products of EB are preferably used because good balance among flexibility, heat-resistant life, and creep durability is achieved.

Commercially available products can be used as the second copolymer. Examples of acid-modified products of EB include commercially available products such as TAFMER MH5020 (density 0.866), TAFMER MH7010 (density 0.870), and TAFMER MH7020 (density 0.873) (all of which are manufactured by Mitsui Chemicals, Inc.).

The content of the second copolymer is 10% by mass or more and preferably 20% to 80% by mass of the total content of the first copolymer, the second copolymer, and the third copolymer. At a content of the second copolymer of less than 10% by mass, the adhesion to an adhesive becomes insufficient when the adhesive is used for water cut-off at a terminal, and a stable strip force is not obtained. When the adhesion is insufficient, the terminal water cut-off structure cannot be reliably obtained, resulting in contact failure in a connector portion. Furthermore, when the strip force is unstable, the resulting insulating layer cannot be appropriately removed for terminal processing, resulting in a decrease in work efficiency. When the content of the second copolymer is 20% by mass or more, sufficient adhesion to an adhesive used for water cut-off at a terminal is obtained, which is preferable. On the other hand, when the content exceeds 80% by mass, adhesion to a conductor is excessively high, which may result in an excessively large strip force.

The third copolymer is selected from the group consisting of ethylene-acrylic acid ester copolymers and ethylene-methacrylic acid ester copolymers. Specifically, examples thereof include ethylene-methyl acrylate, ethylene-ethyl acrylate, ethylene-butyl acrylate, ethylene-methyl methacrylate, ethylene-ethyl methacrylate, and ethylene-butyl methacrylate.

Of these, ethylene-ethyl acrylate copolymers (EEA) are preferred from the viewpoint of flexibility and heat resistance. In particular, ethylene-ethyl acrylate copolymers (EEA) having an ethyl acrylate (EA) ratio of 20% (molar ratio) or more are preferred.

Accordingly, an embodiment in which the third copolymer is an EEA is provided as a preferred embodiment. Examples of the EEA that can be used include commercially available products such as REXPEARL A4250 (manufactured by Japan Polyethylene Corporation, EA ratio 25%), DFDJ6182, NUC-6510 (manufactured by NUC Corporation, EA ratio 23%), NUC-6520 (manufactured by NUC Corporation, EA ratio 24%), and DPDJ-6182 (manufactured by NUC Corporation, EA ratio 15%).

The content of the third copolymer satisfies a ratio of the total content of the first copolymer and the second copolymer to the content of the third copolymer (mass ratio) in the range of 100:0 to 40:60, and preferably 80:20 to 40:60. In the range of 100:0 to 40:60, good flexibility, high tensile strength, good adhesion to an adhesive when the adhesive is used for water cut-off at a terminal, and a stable strip force are obtained. When the content of the third copolymer (mass ratio) exceeds 60% of the total content of the first copolymer, the second copolymer, and the third copolymer, the 2% secant modulus of elasticity of the crosslinked material exceeds 35 MPa, and good flexibility that fulfills the recent requirements is not obtained.

In recent years, there have been an increasing number of cases where the continuous heat resistance temperature (the heat-resistant life specified in the standards of Japanese Automotive Standards Organization (JASO)) at which a 100% elongation is obtained for an insulator exposed to heating for 10,000 hours is required to be 150° C. or higher. When the ratio of the third copolymer is 20% by mass of more (the ratio of the total content of the first copolymer and the second copolymer is 80% by mass or less), good heat resistance that fulfils this requirement is obtained. Thus, an embodiment in which the ratio (mass ratio) of the total content of the first copolymer and the second copolymer to the content of the third copolymer is 80:20 to 40:60 is provided as a preferred embodiment.

To improve flame retardancy of the insulated electric wire, a flame retardant is blended in the insulating resin composition of the first embodiment. The content of the flame retardant in the resin composition is 30 to 100 parts by mass relative to 100 parts by mass of the resin component. When the content of the flame retardant is less than 30 parts by mass, sufficient flame retardancy is not obtained. In contrast, a content of the flame retardant exceeding 100 parts by mass is not preferred because mechanical strength of the insulating layer decreases.

Examples of the flame retardant include magnesium hydroxide, aluminum hydroxide, brominated flame retardants, antimony trioxide, antimony pentoxide, and zinc borate. These flame retardants may be used alone or in combination of two or more thereof. However, magnesium hydroxide and aluminum hydroxide require an increased content in order to obtain sufficient flame retardancy, and often adversely affect properties, for example, decrease mechanical strength and degrade heat resistance. Thus, a brominated flame retardant and antimony trioxide are preferably used in combination as the flame retardant. In particular, 20 to 50 parts by mass of a brominated flame retardant and 5 to 25 parts by mass of antimony trioxide are preferably blended relative to 100 parts by mass of the resin component. A commercially available product such as Saytex 8010 can also be used as the brominated flame retardant.

The content of a crosslinking assistant in the insulating resin composition of the first embodiment is 1 to 5 parts by mass relative to 100 parts by mass of the resin component. When the content of the crosslinking assistant is less than 1 part by mass, crosslinking does not proceed sufficiently, and mechanical strength of the insulating layer may decrease. In contrast, a content of the crosslinking assistant exceeding 5 parts by mass is not preferred because the crosslinking density increases excessively and the insulating layer has a high hardness, resulting in a decrease in flexibility. Examples of the crosslinking assistant include isocyanurates such as triallyl isocyanurate (TAIC) and diallyl monoglycidyl isocyanurate (DA-MGIC), and trimethylolpropane trimethacrylate. These crosslinking assistants may be used alone or in combination of two or more thereof. Of these, trimethylolpropane trimethacrylate is preferred in order to effectively achieve crosslinking.

Other components can be optionally added to the insulating resin composition of the first embodiment as long as the gist of the present invention is not impaired. Examples of the other components include a lubricant, a processing aid, a coloring agent, an antioxidant, zinc oxide, and a die lip buildup inhibitor. Examples of the antioxidant include sulfur-containing antioxidants and phenolic antioxidants. Preferably, the antioxidant is added in an amount of 10 to 40 parts by mass relative to 100 parts by mass of the resin component because oxidation degradation of the resin can be effectively suppressed within a range that does not impair the gist of the present invention.

The insulating resin composition of the first embodiment is produced by kneading the above-described essential components and optional components. Various known means can be used as the kneading method. As a kneading machine, a single-screw extruder, a twin-screw extruder, a Banbury mixer, a kneader, a roll mill, and other known kneading machines can be used. For example, a method that includes performing pre-blending in advance by using a high-speed mixer such as a Henschel mixer, and subsequently performing kneading by using the above-described kneading machine may also be employed.

A second embodiment of the present invention is

an insulated electric wire including a conductor and an insulating layer covering the conductor either directly or with another layer therebetween, in which the insulating layer is formed of the insulating resin composition of the first embodiment, and the resin is crosslinked. The insulated electric wire of the second embodiment has good properties, such as flexibility, of existing insulated electric wires. Furthermore, since the insulating layer of this insulated electric wire is formed of a crosslinked material of the insulating resin composition of the first embodiment, the insulating layer has high tensile strength, good adhesion to an adhesive when the adhesive is used for water cut-off at a terminal, and a stable strip force.

The insulated electric wire of the second embodiment encompasses not only a single insulated electric wire that includes a conductor and an insulating layer covering the conductor but also a bundle of a plurality of such insulated electric wires. An example of the bundle of a plurality of such insulated electric wires is a wire harness used for wiring in automobiles. The type and structure of the insulated electric wire are not limited, and examples of the insulated electric wire include single wires, flat wires, and shielded wires.

The conductor of the insulated electric wire is made of a metal, such as copper or aluminum, and provided in the form of a long line. The number of conductors may be one, or two or more.

The conductor is covered with an insulating layer formed by the insulating resin composition of the first embodiment. The second embodiment includes both a case where the conductor is directly covered and a case where the conductor is covered with another layer therebetween. An example of the insulating layer that covers the conductor with another layer therebetween is a sheath layer covering the outer side of a conductive layer that is formed on the outer side of an insulated electric wire.

The outer side of the conductor is directly covered with the insulating resin composition of the first embodiment, or the outer side of another layer covering the conductor is covered with the insulating resin composition of the first embodiment, and crosslinking of the resin is subsequently performed. The covering with the insulating resin composition of the first embodiment can be performed by various known means, such as extrusion molding, which is typically used in the production of an insulated electric wire. For example, the covering can be performed by using a single-screw extruder having a cylinder diameter Φ of 20 mm to 90 mm with L/D=10 to 40. The crosslinking of the resin can be performed by irradiating the conductor after covering with an ionizing radiation such as an electron beam.

A wire harness is obtained by binding together a plurality of insulated electric wires obtained as described above. For example, a connector is attached to a terminal of a single wire of an insulated electric wire or terminals of insulated electric wires of a wire harness or the like. The connector fits into a connector provided on another electronic device, and the insulated electric wire transmits power, control signals, and the like to the electronic device.

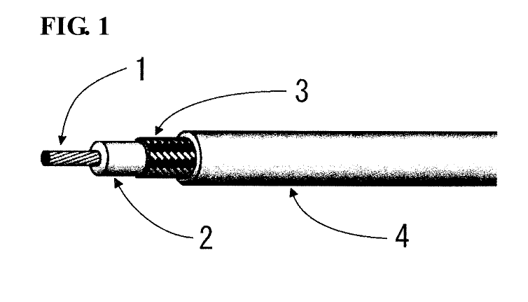

FIG. 1 is a perspective (partially cut-away) view of a structure of an example (shielded electric wire) of the insulated electric wire of the second embodiment. In the drawing, 1 denotes a conductor. In this example, the conductor 1 is a stranded wire obtained by stranding a plurality of element wires. In the drawing, 2 denotes an insulating layer that directly covers the conductor 1, and 3 denotes a shield layer that is formed of a braided mesh of a conductive (or semi-conductive) material and provided to block the influence of electromagnetic waves from the outside. In this example, the outer side of the shield layer 3 is also covered with an insulating layer (sheath) 4.

The insulating resin composition of the first embodiment can be used to form the insulating layer 2 that directly covers the conductor 1 and also can be used to form the insulating layer (sheath) 4 that covers the conductor 1 with another layer such as the insulating layer 2 therebetween.

### Examples

First, materials used in experimental examples will be described below.

### (Materials Used)

### [Resin Composition]

EEA: NUC-6510 (manufactured by NUC Corporation, EA ratio 23%, MI 0.5)
EB: ENGAGE 7467 (manufactured by The Dow Chemical Company, density 0.862, MI 1.2)
Acid-modified EB: TAFMER MH5020 (manufactured by Mitsui Chemicals, Inc.: maleic anhydride-modified-EB, density 0.866, MI 0.6, represented by “MAH-EB” in Tables)
Flame retardant:

| | |
|---|---|
| Brominated flame retardant | Saytex 8010 |

Antimony trioxide
Zinc oxide: zinc oxide Type 1
Antioxidant:

SUMILIZER MB (manufactured by Sumitomo Chemical Company, Limited: sulfur-containing antioxidant)

IRGANOX 1010 (manufactured by BASF: hindered phenol antioxidant)

IRGANOX PS802 (manufactured by BASF: sulfur-containing antioxidant)
Crosslinking assistant:

TD1500s (DIC Corporation: trimethylolpropane trimethacrylate)

### [Electric Wire Structure]

Conductor: 15 sq: Thirty element wires each having an outer diameter of 0.18 mm were stranded into a stranded wire, and nineteen stranded wires prepared in this manner were then stranded into a double-stranded structure: Outer diameter of conductor: 5.5 mm
Insulating layer: 1.25 mm in thickness, Outer diameter of electric wire: 8 mm

### Experiment

Each of the resin compositions mixed at blend ratios (mass ratios) shown in Tables 1 to 3 was extruded onto the conductor to form an insulating layer having the above thickness and covering the conductor. As a result, an insulated electric wire having the electric wire structure described above was obtained. The resin was crosslinked by being irradiated with a 240 kGy electron beam. Subsequently, the tensile strength Ts, tensile elongation EI, 2% secant modulus of elasticity (flexibility), heat-resistant life, and strip force of the insulated electric wire were measured by the methods described below. Tables 1 to 3 show the results.

### [Method for Measuring Tensile Strength Ts and Tensile Elongation EI]

The measurement was conducted in accordance with the JASO D618 insulator tensile test.

### [Method for Measuring 2% Secant Modulus of Elasticity]

A test piece having a length of 100 mm was pulled in the length direction at a tensile rate of 50 mm/min with a tensile tester, and a load at 2% elongation was determined. The load was then divided by a sectional area, and the result was multiplied by 50 to obtain a value of a 2% secant modulus of elasticity (MPa).

### [Method for Evaluating Heat-Resistant Life]

Heat resistance was rated on the basis of a continuous heat resistance temperature according to the standards of Japanese Automotive Standards Organization (JASO). Specifically, an aging test was conducted at temperatures of 170° C., 180° C., 190° C., and 200° C., the time taken for tensile elongation to fall below 100% was measured, and an Arrhenius plot was made. Thus, the temperature (continuous heat resistance temperature) at which 100% elongation was secured in 10,000 hours was determined, and the result was assumed to be the heat-resistant life. The heat-resistant life is preferably 150° C. or higher and more preferably 151° C. or higher.

### [Method for Measuring Strip Force]

An electric wire with a length of 100 mm was taken by cutting, and a part of an insulating layer of the electric wire, the part having a length of 50 mm, was removed. A conductor was inserted into a hole of a plate, the hole having such a size that the conductor passes therethrough, the plate was then fixed with a tensile tester, and the conductor was pulled to remove insulation. The maximum load at that time was measured, and the measured value was assumed to be the strip force.

TABLE 1

| | | Experiment 1 | Experiment 2 | Experiment 3 | Experiment 4 | Experiment 5 | Experiment 6 |
|---|---|---|---|---|---|---|---|
| EEA | | 40 | 40 | 40 | 40 | 40 | 40 |
| EB | | 60 | 50 | 40 | 30 | 20 | 10 |
| MAH-EB | | — | 10 | 20 | 30 | 40 | 50 |
| Flame | Brominated flame | 35 | 35 | 35 | 35 | 35 | 35 |
| retardant | retardant | | | | | | |
| | Antimony trioxide | 10 | 10 | 10 | 10 | 10 | 10 |
| Zinc oxide | | 10 | 10 | 10 | 10 | 10 | 10 |
| Antioxidant | SUMILIZER MB | 10 | 10 | 10 | 10 | 10 | 10 |
| | IRGANOX 1010 | 4 | 4 | 4 | 4 | 4 | 4 |
| | IRGANOX PS802 | 2 | 2 | 2 | 2 | 2 | 2 |

| | | | | | | |
|---|---|---|---|---|---|---|
| Crosslinking assistant | 3 | 3 | 3 | 3 | 3 | 3 |
| Tensile strength Ts (MPa) | 11.8 | 12.0 | 13.6 | 14.2 | 14.5 | 14.9 |
| Tensile elongation EI (%) | 652 | 596 | 664 | 573 | 568 | 511 |
| 2% Secant modulus of | 23 | 23 | 23 | 23 | 23 | 23 |
| elasticity (MPa) | | | | | | |
| Heat-resistant life (° C.) | 151 | 151 | 151 | 151 | 151 | 151 |
| Strip force (kg/50 mm) | 4.4 | 5.0 | 6.0 | 7.6 | 8.2 | 9.3 |

TABLE 2

| | | | | | Experiment | Experiment | Experiment |
|---|---|---|---|---|---|---|---|
| | | Experiment 7 | Experiment 8 | Experiment 9 | 10 | 11 | 12 |
| EEA | | 40 | 100 | 90 | 80 | 70 | 60 |
| EB | | — | — | 5 | 10 | 15 | 20 |
| MAH-EB | | 60 | — | 5 | 10 | 15 | 20 |
| Flame | Brominated flame retardant | 35 | 35 | 35 | 35 | 35 | 35 |
| retardant | Antimony trioxide | 10 | 10 | 10 | 10 | 10 | 10 |
| Zinc oxide | | 10 | 10 | 10 | 10 | 10 | 10 |
| Antioxidant | SUMILIZER MB | 10 | 10 | 10 | 10 | 10 | 10 |
| | IRGANOX 1010 | 4 | 4 | 4 | 4 | 4 | 4 |
| | IRGANOX PS802 | 2 | 2 | 2 | 2 | 2 | 2 |

| | | | | | | |
|---|---|---|---|---|---|---|
| Crosslinking assistant | 3 | 3 | 3 | 3 | 3 | 3 |
| Tensile strength Ts (MPa) | 15.0 | 15.6 | 15.0 | 15.0 | 14.8 | 14.6 |
| Tensile elongation EI (%) | 485 | 465 | 480 | 498 | 488 | 522 |
| 2% Secant modulus | 23 | 39 | 38 | 37 | 36 | 30 |
| of elasticity (MPa) | | | | | | |
| Heat-resistant life (° C.) | 151 | 152 | 152 | 152 | 152 | 151 |
| Strip force (kg/50 mm) | 10.0 | 3.2 | 4.2 | 5.1 | 6.0 | 6.5 |

TABLE 3

| | | Experiment | Experiment | Experiment | Experiment | Experiment | Experiment |
|---|---|---|---|---|---|---|---|
| | | 13 | 14 | 15 | 16 | 17 | 18 |
| EEA | | 50 | 40 | 30 | 20 | 10 | — |
| EB | | 25 | 30 | 35 | 40 | 45 | 60 |
| MAH-EB | | 25 | 30 | 35 | 40 | 45 | 50 |
| Flame | Brominated flame retardant | 35 | 35 | 35 | 35 | 35 | 35 |
| retardant | Antimony trioxide | 10 | 10 | 10 | 10 | 10 | 10 |
| Zinc oxide | | 10 | 10 | 10 | 10 | 10 | 10 |
| Antioxidant | SUMILIZER MB | 10 | 10 | 10 | 10 | 10 | 10 |
| | IRGANOX 1010 | 4 | 4 | 4 | 4 | 4 | 4 |
| | IRGANOX PS802 | 2 | 2 | 2 | 2 | 2 | 2 |

| | | | | | | |
|---|---|---|---|---|---|---|
| Crosslinking assistant | 3 | 3 | 3 | 3 | 3 | 3 |
| Tensile strength Ts (MPa) | 14.2 | 14.2 | 13.3 | 12.3 | 11.0 | 10.4 |
| Tensile elongation EI (%) | 550 | 573 | 628 | 680 | 706 | 790 |
| 2% Secant modulus of | 25 | 23 | 20 | 18 | 16 | 14 |
| elasticity (MPa) | | | | | | |
| Heat-resistant life (° C.) | 151 | 151 | 151 | 150 | 148 | 146 |
| Strip force (kg/50 mm) | 7.2 | 7.6 | 8.0 | 8.5 | 9.1 | 9.2 |

As shown in Tables 1 to 3, in the cases of the use of the compositions of Experiments 2 to 7 and Experiments 12 to 18, which contained MAH-EB (second copolymer) that was an acid-modified copolymer of ethylene and an unsaturated hydrocarbon having 4 or more carbon atoms and that had a density of less than 0.88 g/cm³ in an amount of 10% by mass or more relative to the total content of EEA (third copolymer), EB (first copolymer), and MAH-EB, and in which the content of EEA was 60% by mass or less relative to the total content of EEA, EB, and MAH-EB, the tensile strength was 10.4 MPa or more, and the 2% secant modulus of elasticity was 30 MPa or less. That is, these results showed that a 2% secant modulus of elasticity of 35 MPa or less, which was in a range of good flexibility fulfilling the recent requirements, and a tensile strength of 10.3 MPa or more could be realized. Furthermore, in Experiments 2 to 7 and Experiments 12 to 18, the strip force was in a range of 5 to 10 kg/50 mm (in a range of a stable strip force).

However, in Experiments 1, 8, and 9, in which MAH-EB is not contained or the content of MAH-EB is less than 10% by mass, the strip force is less than 5 kg/50 mm, and a stable strip force is not obtained. These results show that the content of MAH-EB needs to be 10% by mass or more relative to the total content of EEA, EB, and MAH-EB in order to obtain a stable strip force.

In Experiments 8 to 11, in which the content of EEA exceeds 60% by mass relative to the total content of EEA, EB, and MAH-EB, the 2% secant modulus of elasticity of the crosslinked material exceeds 35 MPa. Accordingly, these results show that the content of EEA needs to be 60% by mass or less relative to the total content of EEA, EB, and MAH-EB in order to obtain good flexibility that fulfills the recent requirements.

In Experiments 17 and 18, in which the content of EEA is less than 20% by mass relative to the total content of EEA, EB, and MAH-EB, a heat-resistant life of 150° C. or higher is not obtained. These results show that the content of EEA is preferably 20% by mass or more relative to the total content of EEA, EB, and MAH-EB.

1. An insulating resin composition comprising:
a resin component containing
a first copolymer which is a copolymer of ethylene and an unsaturated hydrocarbon having 4 or more carbon atoms and which has a density of less than 0.88 g/cm³,
a second copolymer which is a copolymer of ethylene and an unsaturated hydrocarbon having 4 or more carbon atoms, which is subjected to acid modification, and which has a density of less than 0.88 g/cm³, and
a third copolymer which is a copolymer of ethylene and an acrylic acid ester or a methacrylic acid ester,
wherein a content of the second copolymer is 10% by mass or more of a total content of the first copolymer, the second copolymer, and the third copolymer, and
a ratio (mass ratio) of a total content of the first copolymer and the second copolymer to a content of the third copolymer is 100:0 to 40:60; and
30 to 100 parts by mass of a flame retardant and 1 to 5 parts by mass of a crosslinking assistant relative to 100 parts by mass of the resin component.

2. The insulating resin composition according to claim 1, wherein the third copolymer is an ethylene-ethyl acrylate copolymer.

3. The insulating resin composition according to claim 1, wherein the ratio (mass ratio) of the total content of the first copolymer and the second copolymer to the content of the third copolymer is 80:20 to 40:60.

4. The insulating resin composition according to claim 1, wherein the flame retardant is a mixture of a brominated flame retardant and antimony trioxide.

5. An insulated electric wire comprising a conductor and an insulating layer covering the conductor either directly or with another layer therebetween, wherein the insulating layer is formed of a crosslinked material of the insulating resin composition according to claim 1.
